(19) United States
(12) Patent Application Publication
(10) Pub. No.: US 2025/0326013 A1
(43) Pub. Date: Oct. 23, 2025

(54) ESCUTCHEON AND VESSEL RINSING DEVICE WITH SOAP DISPENSER

(71) Applicant: Kohler Co., Kohler, WI (US)

(72) Inventors: Carlos Felipe Uceda, Atlanta, GA (US); Erich Slothower, Mill Valley, CA (US); Joyce Kung, San Francisco, CA (US)

(21) Appl. No.: 19/096,313

(22) Filed: Mar. 31, 2025

Related U.S. Application Data
(60) Provisional application No. 63/636,983, filed on Apr. 22, 2024.
(60) Provisional application No. 63/642,325, filed on May 3, 2024.

(51) Int. Cl. B08B 9/093; B05B 7/00

(52) U.S. Cl. CPC B08B 9/093; B05B 7/00

(57) ABSTRACT

A vessel rinsing device configured to apply pressurized water and soap to a vessel or other similar container with the objective of cleaning and rinsing the vessel. In examples, a vessel rinsing device may include a mounting element disposed below a lower escutcheon, an upper escutcheon couped to the lower escutcheon, a fluid dispersion assembly disposed within the upper escutcheon, and a soap dispenser defined within a portion of the lower escutcheon. The soap dispenser can dispense soap into a water stream to create a water and soap mixture. Optionally, the vessel rinsing device can include a pair of water type indicators for differentiating between hot and cold water, and a light-emitting diode for providing illumination during vessel cleaning operations. Vessel rinsing systems and methods of operating a vessel rinsing device are also provided by the present disclosure. Escutcheons with vessel rinsing devices and waterfall features are also provided herein.

### CROSS-REFERENCE TO RELATED APPLICATIONS

This application claims the benefits of U.S. Provisional Patent Application No. 63/636,983, titled VESSEL RINSING DEVICE WITH SOAP DISPENSER and filed Apr. 22, 2024, and U.S. Provisional Patent Application No. 63/642,325, titled ESCUTCHEON WITH VESSEL RINSING DEVICE and filed May 3, 2024. The entire disclosures of the foregoing applications are hereby incorporated by reference herein.

### TECHNICAL FIELD

The present disclosure generally relates to a fluid dispensing device. More specifically, the present disclosure relates to escutcheons and fluid and soap dispensing devices couplable to a sink deck and configured for use with vessels and other similar fluid containers.

### BACKGROUND

It is often difficult to clean the interior of a vessel such as a glass or a cup. Debris can become lodged deep inside the vessel which makes cleaning challenging especially when the vessel has a small diameter opening. Conventional approaches to cleaning vessels include, for example, brushes, rags, spray faucets, or simply placing the dirtied vessel in a dishwasher for automatic cleaning. While these approaches may prove effective on occasion, they typically leave at least some debris in hard-to-reach areas deep inside the vessel that cannot be removed without recleaning the vessel using a different approach. Moreover, these approaches are either excessive (e.g., spray faucets, dishwasher) or require too much manual labor from the vessel cleaner (e.g., brushes, rags).

Other more recent approaches include using a vessel rinsing apparatus connected to a sink deck surface to provide pressurized water directly into the vessel when a force is applied against the apparatus. While these more recent approaches tend to remedy the issue of providing water directly to hard-to-reach areas, they typically do not integrate soap or another cleaning product into the directed water stream when cleaning the vessel. Accordingly, the current line of vessel rinsing apparatuses fail to provide complete vessel cleanliness because they do not remove all germs, chemicals, and other unsavory substances removable using a combination of water and a cleaning product. Examples of the present disclosure provide solutions to this problem as well as other problems that will become apparent in subsequent sections herein.

### SUMMARY

Examples of the present disclosure relate to a vessel rinsing device configured to apply pressurized water to a vessel or other similar container with the objective of cleaning and rinsing the vessel or container. In examples, a vessel rinsing device may include a mounting element disposed below a lower escutcheon, an upper escutcheon couplable to the lower escutcheon, a fluid dispersion assembly disposed within the upper escutcheon, and a soap dispenser defined within a portion of the lower escutcheon. Optionally, the vessel rinsing device can include a pair of water type indicators for differentiating between hot and cold water, and a light-emitting diode for providing illumination during vessel cleaning operations.

In other examples, a method of operating a vessel rinsing device may include positioning a dirtied vessel above a vessel rinsing device for cleaning and rinsing. The method may include exerting force using the dirtied vessel against a trigger mechanism of the vessel rinsing device, for example a plurality of arms or a trigger plate. The method may include activating water dispersal through a plurality of nozzles defined within a dome of the vessel rinsing device, in response to the exertion of force, and thereafter directing the water dispersal into the dirtied vessel for cleaning and rinsing. The method may include removing the cleaned vessel from the trigger mechanism which stops the flow of water through the plurality of nozzles and effectively turns off the vessel cleaning device.

### BRIEF DESCRIPTION OF THE DRAWINGS

The disclosure may be more completely understood in consideration of the following detailed description of examples of the disclosure in connection with the accompanying drawing, in which:

FIG. 1A is a perspective view of a vessel rinsing device, according to examples of the present disclosure;

FIG. 1B is a detail view of a fluid dispersion assembly of the vessel rinsing device of FIG. 1A, according to examples of the present disclosure;

FIG. 2 is a side view of the vessel rinsing device of FIG. 1A, according to examples of the present disclosure;

FIG. 3 is a schematic view of a Venturi system for use with a vessel rinsing device, according to examples of the present disclosure;

FIG. 4 is a method of operating a vessel rinsing device, according to examples of the present disclosure;

FIG. 5 is a method of operating a vessel rinsing device, according to examples of the present disclosure;

FIG. 6 is a perspective view of a vessel rinsing device, according to examples of the present disclosure;

FIG. 7 is a perspective view of a vessel rinsing device, according to examples of the present disclosure;

FIG. 8 is a perspective view of a vessel rinsing device, according to examples of the present disclosure;

FIG. 9 is a perspective view of a vessel rinsing device, according to examples of the present disclosure;

FIG. 10 is a perspective view of a vessel rinsing device, according to examples of the present disclosure;

FIG. 11 is a perspective view of a drain assembly for use with a vessel rinsing device, according to examples of the present disclosure;

FIG. 12 is a perspective view of a drying apparatus for use with a vessel rinsing device, according to examples of the present disclosure;

FIG. 13A is a perspective view of a vessel rinsing device, according to examples of the present disclosure;

FIG. 13B is a top view of the vessel rinsing device of FIG. 13A, according to examples of the present disclosure;

FIG. 14 is a perspective view of a vessel rinsing device, according to examples of the present disclosure;

FIG. 15A is a perspective view of a vessel rinsing device in a closed configuration, according to examples of the present disclosure;

FIG. 15B is a perspective view of the vessel rinsing device of FIG. 15A in an open configuration, according to examples of the disclosure;

FIG. 16A is a perspective view of a vessel rinsing device with an airgap, according to examples of the present disclosure;

FIG. 16B is a side view of a vessel rinsing device with an airgap and plumbing schematic, according to examples of the present disclosure;

FIG. 17A is a perspective view of an escutcheon with a vessel rinsing device, according to examples of the present disclosure;

FIG. 17B is a perspective view of an escutcheon with a vessel rinsing device, according to examples of the present disclosure; and

FIG. 18 is a perspective view of an escutcheon with a vessel rinsing device and a waterfall feature, according to examples of the present disclosure.

While various examples are amenable to various modifications and alternative forms, specifics thereof have been shown by way of example in the drawings and will be described in detail. It should be understood, however, that the intention is not to limit the claimed inventions to the particular examples described. On the contrary, the intention is to cover all modifications, equivalents, and alternatives falling within the spirit and scope of the subject matter as defined by the claims.

### DETAILED DESCRIPTION

The following detailed description should be read with reference to the drawings in which similar elements in different drawings are numbered the same. The drawings, which are not necessarily to scale, depict illustrative examples and are not intended to limit the scope of the disclosure.

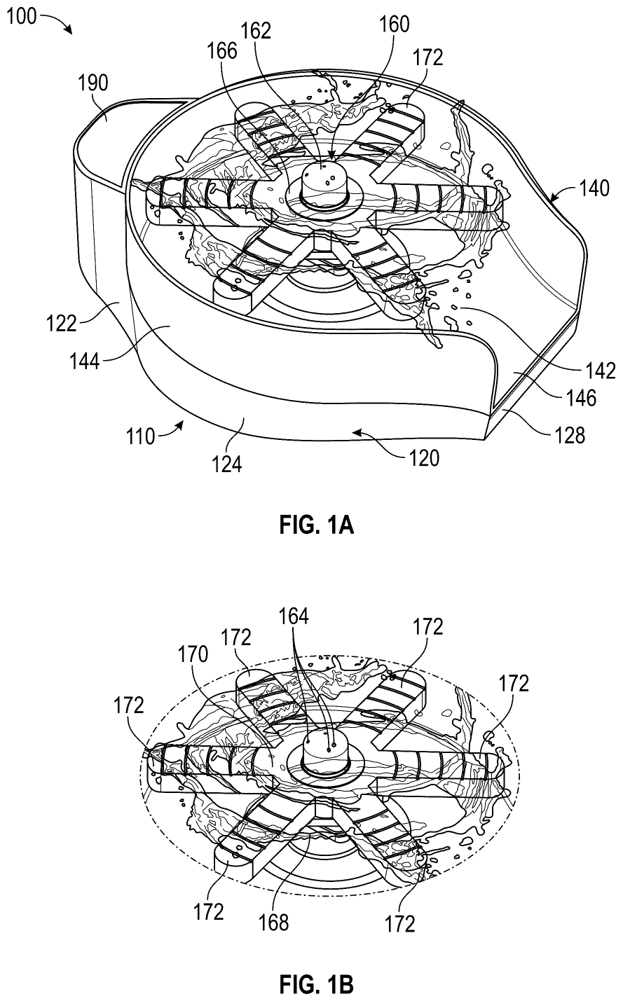

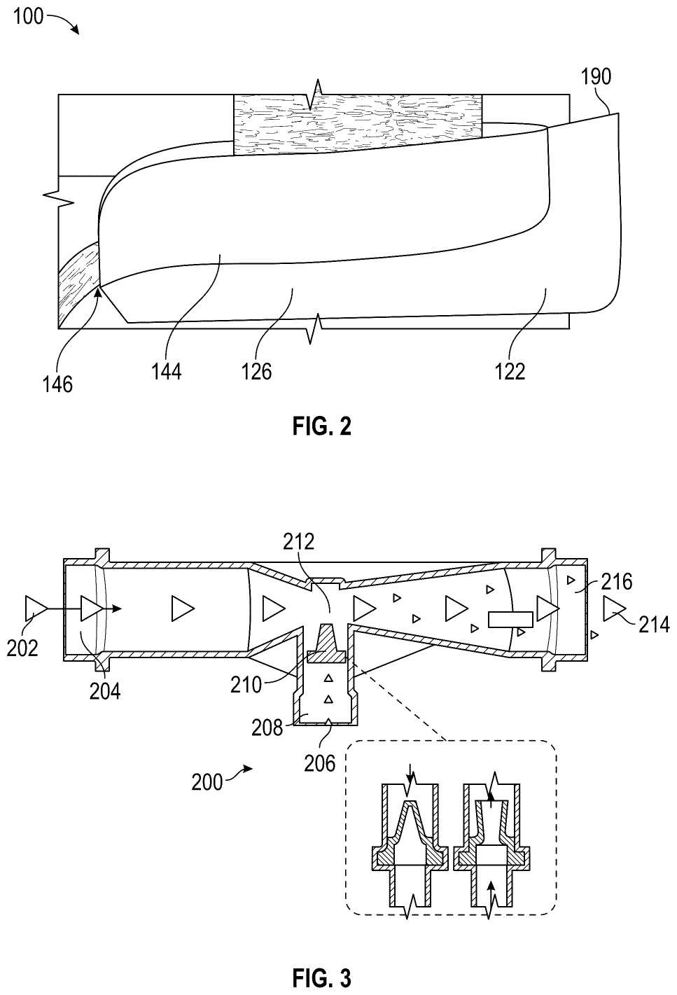

Referring generally to FIGS. 1A, 1B, and 2, a vessel rinsing device 100 may include a mounting element 110 disposed below a lower escutcheon 120, an upper escutcheon 140 couplable to the lower escutcheon 120, a fluid dispersion assembly 160 disposed within the upper escutcheon 140, and a soap dispenser 190 defined within a portion of the lower escutcheon 120.

Mounting element 110, though not explicitly shown in the figures, can be configured to couple vessel rinsing device 100 to a sink deck so device 100 can be operated in the manner contemplated by this disclosure. Mounting element 110 may have an upper portion couplable to a bottom surface of the lower escutcheon 120 and a lower portion couplable to the sink deck. Mounting element 110 may have, for example, a cylindrically shaped geometry with threaded upper and lower portions to enable effective coupling to the sink deck. The sink deck generally defines an aperture through which the mounting element 110 extends through, thereby enabling the bottom surface of the lower escutcheon 120 to rest directly on a top surface of the sink deck when the mounting element 110 is coupled to the sink deck. Mounting element 110 is generally made from a metallic material, though other suitable materials such as insoluble polymers, composite materials, and ceramics may be used. The length, width, diameter, and other measurements of mounting element 110 may vary depending on the type of sink deck being used, the proximity of the sink deck to external plumbing features, or the preferences of the user of the vessel rinsing device 100.

To enable water transport to the vessel rinsing device 100, mounting element 110 generally defines an internal chamber extending from one open end to another open end. For example, using the example of mounting element 110 with upper and lower portions, the lower portion can define a first opening configured to receive a water transport element such as a hose or another suitable water passageway. The water transport element may extend through the internal chamber defined by the upper and lower portions and extend further beyond a second opening defined by the upper portion and into the lower and upper escutcheons 120, 140 of the vessel rinsing device 100. Accordingly, mounting element 110 additionally enables the transport of water or other fluids from an external source to other components of vessel rinsing device 100, to be used for vessel rinsing operations.

In general, mounting element 110 can be disposed below lower escutcheon 120 so as to couple lower escutcheon 120 and the remaining components of vessel rinsing device 100 to the sink deck. Lower escutcheon 120 may include a soap container 122, a first rounded edge 124, a second rounded edge 126, and a lower wall 128, as depicted particularly in FIGS. 1A and 2. Lower escutcheon 120 is generally made from a metallic material, though other suitable materials such as insoluble polymers, composite materials, and ceramics may be used.

Soap container 122 can be configured to hold soap or other cleaning products for use in vessel rinsing operations. In general, soap container 122 can be defined as a thin-walled container oriented perpendicular to the top surface of the sink deck as shown, for example, in FIG. 2. Accordingly, soap and other cleaning products can be easily inserted into soap container 122 from above without having to reorient the configuration of vessel rinsing device 100 or remove device 100 from the sink deck. Specifically, soap container 122 may define an outer surface facing toward the external environment and an inner surface that defines an open space for containing soap or other cleaning products. The shape and size of soap container 122 may vary depending on the amount of cleaning product to be stored. Generally, soap container 122 has a rectangular geometry with rounded edges and has an area of approximately one to five inches-squared, though other shapes and sizes suitable for containing soap and other cleaning products are contemplated by this disclosure.

Soap container 122 is generally fixedly couplable to first and second rounded edges 124, 126 as illustrated in FIGS. 1A and 2. First and second rounded edges 124, 126 are generally positioned on opposite sides of vessel rinsing device 100 and together form a circular cross-section when viewed from above. First and second rounded edges 124, 126, considered together with a bottom horizontal surface of soap container 122, form a bottom surface of lower escutcheon 120 that generally rests directly on a top surface of the sink deck as described previously. The bottom surface of lower escutcheon 120 is generally parallel or somewhat parallel with the top surface of the sink deck to eliminate or reduce misalignment between the two surfaces.

The combination of first and second rounded edges 124, 126 and a vertical outer surface of soap container 122 also form a top surface of lower escutcheon 120 configured to receive upper escutcheon 140. The top surface of lower escutcheon 120 is generally parallel or somewhat parallel with a bottom surface of upper escutcheon 140 to eliminate or reduce misalignment between the two surfaces. In examples, the top surface may have a downward slope to match a corresponding sloped surface of the upper escutcheon 140. First and second rounded edges 124, 126 extend from soap container 122 to a lower wall 128 which itself extends from the bottom surface to the top surface of lower escutcheon 120. Generally, lower wall 128 is angled outward from the sink deck so as to match the geometry of upper escutcheon 140 to facilitate the downstream flow of water out of vessel rinsing device 100 and into a sink.

As mentioned, upper escutcheon 140 generally rests directly on the top surface of lower escutcheon 120 formed by first and second rounded edges 124, 126 and the vertical outer surface of soap container 122. Upper escutcheon 140 may include a drain bowl 142, an upwardly extending wall 144 defined on the periphery of drain bowl 142, and a drain channel 146 configured to remove water out of the drain bowl 142 and into a sink. Upper escutcheon 140 is generally made from a metallic material such as stainless steel, though other suitable materials such as insoluble polymers, composite materials, and ceramics may be used.

Drain bowl 142 is generally configured to receive water and debris after vessel cleaning device 100 is used to clean and rinse a vessel. As illustrated in FIG. 1A, drain bowl 142 may have a generally circular geometry that matches the profile of first and second rounded edges 124, 126. Other geometries including, for example, square, rectangular, triangular, or perfectly circular may also be used for drain bowl 142. The size of drain bowl 142 may vary depending on the size of the vessels to be used, but drain bowl 142 generally comprises an area of approximately five to 15 inches-squared (other areas are contemplated by this disclosure).

Upwardly extending wall 144 can be defined on an outer periphery of drain bowl 142 as illustrated in FIGS. 1A and 2. As the name suggests, upwardly extending wall 144 is generally a vertical wall surrounding the outer edge of drain bowl 142 that can be configured to contain water and debris therein. Upwardly extending wall 144 may have a variable height to match the downward slope of the top surface of the lower escutcheon 120, and generally has a height less than a corresponding height of soap container 122. In examples, the edge joining drain bowl 142 to upwardly extending wall 144 may be chamfered or filleted, as shown in FIG. 1A, to reduce stress concentrations.

Drain channel 146 can be integrated directly into drain bowl 142 such that water and debris from vessel rinsing operations can flow uninterrupted from drain bowl 142 through drain channel 146 and into a sink for final disposal. In this manner, drain channel 146 can provide fluid communication between drain bowl 142 and the sink which itself is supported by the sink deck on which the vessel cleaning device 100 rests. As illustrated in FIG. 1A, drain channel 146 is located between each end of upwardly extending wall 144 and generally extends outward to the same degree as lower wall 128 of lower escutcheon 120. In examples, drain channel 146 may have a length of approximately one to six inches though other suitable lengths less than or greater than this range are contemplated herein.

Located within drain bowl 142, fluid dispersion assembly 160 may include a dome 162, a plurality of nozzles 164, a support member 166, a fluid connector 168, a central connector 170, and a plurality of spaced-apart arms 172 extending from the central connector 170. Dome 162 may have a hemispherical geometry defining a plurality of openings which function as nozzles 164. When water is received from mounting element 110 through fluid connector 168 and into dome 162, the water exits dome 162 through the plurality of nozzles 164 which provides pressurized water release into a vessel for cleaning and rinsing operations.

Generally, dome 162 can be configured to rotate around an axis to spray water out of the plurality of nozzles 164 and into the vessel all along a 360-degree path of rotation. Accordingly, each area of the dirtied vessel can be adequately reached to ensure complete cleaning and rinsing of the vessel, unlike most of the conventional approaches described previously. Dome 162 can be fixedly couplable within drain bowl 142 using support member 166 which extends upward from drain bowl 142 to dome 162, to secure dome 162 in place at or near the center of drain bowl 142.

Fluid dispersion assembly 160 may also include a central connector 170 having a plurality of spaced-apart arms 172 extending outward from the central connector 170. Central connector 170 and plurality of arms 172 can be integral with each other such that they embody a single component when added to vessel rinsing device 100. Central connector 170 generally has a circular geometry with an aperture defined in a center portion. During assembly, support member 166 can be inserted into the aperture to securely couple both central connector 170 and the plurality of arms 172 to support member 166.

Each arm of the plurality of arms 172 generally extends outward from central connector 170 in a horizontal direction as illustrated by FIGS. 1A and 1B. In examples, plurality of arms 172 may include six evenly spaced arms 172 such that each arm 172 is placed approximately 60 degrees apart when oriented on a circular plane. Plurality of arms 172 may comprise any suitable, narrow geometry but generally a rectangular geometry with a rounded edge at an outermost end is sufficient. Additionally, plurality of arms 172 may include a textured pattern such as one or more ridges on a top surface of each arm 172 as shown in the example as illustrated. Connector 170 and plurality of arms 172 are generally made from a polymer material such as silicone, though other suitable materials such as metals, composite materials which may include a polymer, and ceramics are contemplated by this disclosure.

In combination, central connector 170 and plurality of arms 172 may be configured to translate upward and downward relative to the drain bowl 142 to activate (when moved downward) and turn off (when moved upward) the flow of water through the plurality of nozzles 164. Accordingly, central connector 170 and plurality of arms 172 effectively function as a “trigger” for the activation of vessel rinsing device 100 when a vessel is forced against the central connector 170 or the plurality of arms 172.

Depending on the size, a vessel may cover the entire diameter formed by the combination of central connector 170 and plurality of arms 172, or may cover only a portion of the diameter. In situations where the vessel only covers a portion of the diameter, a user of vessel rinsing device 100 may push down on at least one of the plurality of arms 172 to activate the device 100 and enable cleaning and rinsing of the small diameter vessel. This enables use of vessel rinsing device 100 with vessels having different shapes, sizes, and configurations rather than limiting use to a subset of vessels designed in a certain way.

Vessel rinsing device 100 may also include a soap dispenser 190 integrated with the soap container 122 of lower escutcheon 120. As the name suggests, soap dispenser 190 can be configured to dispense soap into the water stream that flows through fluid connector 168 and out of the plurality of nozzles 164 defined within the dome 162. In this manner, a combination of water and soap can be used for vessel cleaning operations rather than just water. In operation, when soap container 122 is filled with soap, a user can apply downward force against soap dispenser 190 to release soap into the water stream. In examples, soap dispenser 190 may be couplable to different locations of vessel rinsing device 100 other than soap container 122, or may be contained with an external component connected to the vessel rinsing device 100.

Referring now to FIG. 3, a schematic view of a Venturi system 200 for use with vessel rinsing device 100 (and other vessel rinsing devices described herein) is shown. In operation, a water flow 202 can be provided into a water inlet 204 defined within a first, leftward portion of Venturi system 200. Water flow 202 can be transported through Venturi system 200 until reaching a second, middle portion where the water will be combined with soap. A soap flow 206 can be provided into a soap inlet 208 defined within the second, middle portion. The soap flow 206 can be transported through a valve 210, which may be a one-way valve, to the location of water flow 202 in second, middle portion. Water flow 202 and soap flow 206 may combine at a contact point 212 within Venturi system 200 to form a combination water/soap flow 214 that exits through a water/soap outlet 216 defined within a third, rightward portion of Venturi system 200. Accordingly, a water and soap combination can be provided by Venturi system 200 and subsequently used with vessel rinsing device 100 and other vessel rinsing devices described herein for cleaning operations.

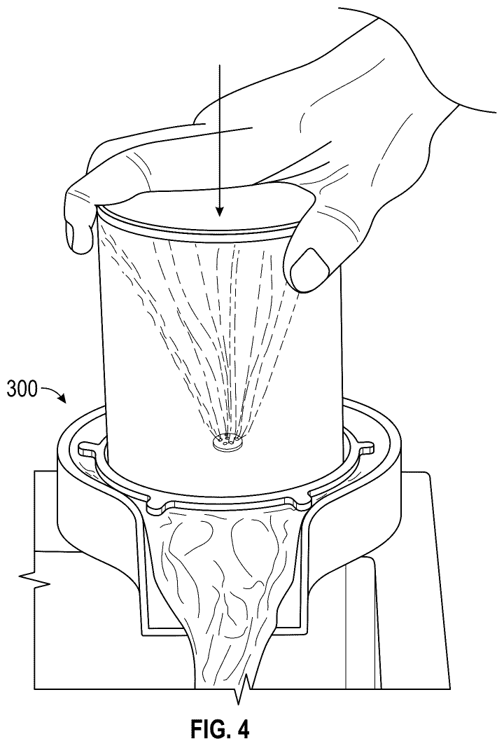

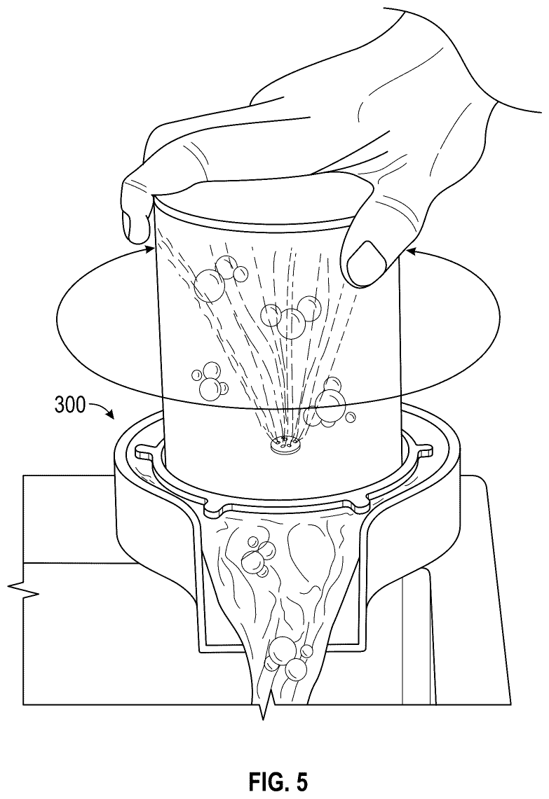

Referring generally to FIGS. 4 and 5, a method of operating a vessel rinsing device 300 is shown. Vessel rinsing device 300 may be replaced with vessel rinsing device 100 without any loss of the functionality illustrated by FIGS. 4 and 5 and described subsequently. The method of operating vessel rinsing device 300 includes placing a vessel against a fluid dispersion assembly and applying downward force using the vessel against the assembly. The application of downward force activates the fluid dispersion assembly which can then spray water out of a plurality of nozzles in a rotating pattern to clean and rinse the vessel.

As shown by FIG. 5, the method may include activating a soap dispenser by rotating the vessel clockwise or counterclockwise. The activation of the soap dispenser provides dispersal of a combination of water and soap (“soapy water”) out of the plurality of nozzles. The “soapy water” can be turned off by rotating the vessel back to a middle position which resumes the dispersal of plain water. Wastewater and debris generated from the vessel cleaning operations can be transported downstream from a drain bowl through a drain channel and into a sink positioned below the vessel rinsing device 300.

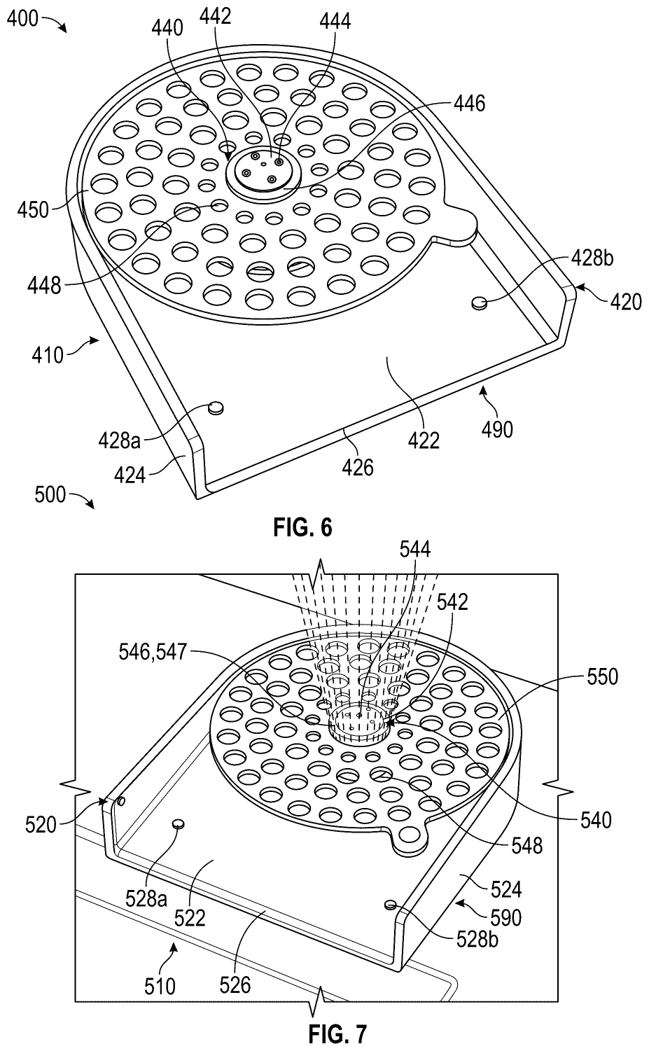

Referring now to FIG. 6, a vessel rinsing device 400 may include a mounting element 410 disposed below an escutcheon 420, a fluid dispersion assembly 440 disposed within the escutcheon 420, and a soap dispenser 490. Vessel rinsing device 400 has many similarities to vessel rinsing device 100 and for simplicity the description of common components is not repeated in the following. Like reference numerals and features names may designate like feature names throughout that are corresponding or analogous.

Escutcheon 420 is generally similar to a combination of lower and upper escutcheons 120, 140 from vessel rinsing device 100, in that a bottom surface of escutcheon 420 can be placed flush against a top surface of a sink deck and a top surface of escutcheon 420 may contain fluid dispersion assembly 440 (similar to upper escutcheon 140 containing fluid dispersion assembly 160). In addition to drain bowl 422, which may have an oval slot geometry as shown in FIG. 6, and upwardly extending wall 424 and drain channel 426, escutcheon 420 may include a hot water indicator 428a and a cold water indicator 428b couplable to the drain bowl 422.

As the names suggest, hot and cold water indicators 428a,b can be used to provide an indication to the user of which type of water is currently being supplied through the fluid dispersion assembly 440. Additionally, a user can change the type of water from hot to cold, or vice versa, by adjusting the position of a trigger plate 450 of the fluid dispersion assembly 440 from facing hot water indicator 428a to facing cold water indicator 428b, or vice versa (e.g., FIG. 6 illustrates trigger 450 facing cold water indicator 428b). In examples, hot water indicator 428a may include the color red to indicate hot water, while the cold water indicator 428b may include the color blue to indicate cold water.

Fluid dispersion assembly 440 is structurally and functionally similar to fluid dispersion assembly 160, but generally does not include a central connector 170 and plurality of arms 172 for triggering water dispersal. Instead, fluid dispersion assembly 440 may include a trigger plate 450 couplable to support member 446, the trigger plate 450 being configured to activate (when trigger plate 450 is moved downward) and turn off (when trigger plate 450 is moved upward) the flow of water through the plurality of nozzles 444 defined within dome 442, when an external force is applied against the trigger plate 450. Trigger plate 450 generally has a circular geometry as shown in FIG. 6, but other geometries including square, rectangular, and triangular are contemplated by this disclosure. Moreover, trigger plate 450 can define a plurality of spaced-apart apertures primarily for weight reduction and aesthetic purposes as shown in FIG. 6.

Referring now to FIG. 7, a vessel rinsing device 500 may include a mounting element 510 disposed below an escutcheon 520, a fluid dispersion assembly 540 disposed within the escutcheon 520, and a soap dispenser 590. Vessel rinsing device 500 has many similarities to vessel rinsing device 400 and for simplicity the description of common components is not repeated in the following. Like reference numerals and features names may designate like feature names throughout that are corresponding or analogous.

Additionally, fluid dispersion assembly 540 may include a light-emitting diode (LED) 547 couplable or otherwise connected to support member 546. LED 547 can provide illumination during vessel cleaning operations to help determine the extent to which a vessel has been cleaned or rinsed. LED 547 may be activated and turned off concurrently with trigger plate 550 or may be controlled using an external control source such as a light switch electrically connected to the vessel rinsing device 500. In examples, a water turbine may generate power for use by the LED 547 as water is transported through the turbine during use.

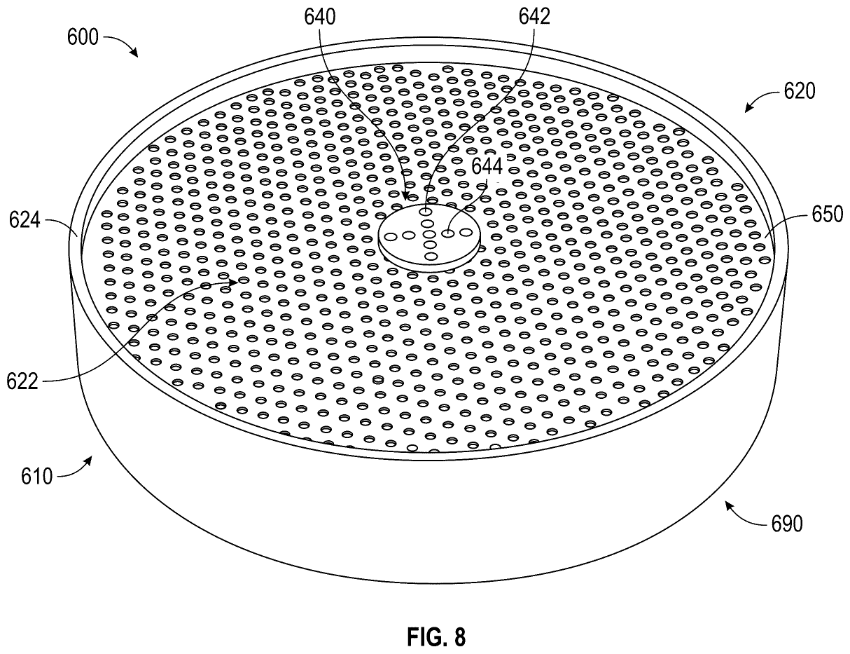

Referring now to FIG. 8, a vessel rinsing device 600 may include a mounting element 610 disposed below an escutcheon 620, a fluid dispersion assembly 640 disposed within the escutcheon 620, and a soap dispenser 690. Vessel rinsing device 600 has many similarities to vessel rinsing devices 400, 500 and for simplicity the description of common components is not repeated in the following. Like reference numerals and features names may designate like feature names throughout that are corresponding or analogous.

Rather than having a drain channel for directing wastewater and debris into a sink, escutcheon 620 of vessel rinsing device 600, which is circular in shape as shown in FIG. 8, includes a drain (not explicitly depicted in FIG. 8) disposed directly inside the drain bowl 622 for removing such contaminants. This eliminates the need for an opening in the upwardly extending wall 624 to define a drain channel in fluid communication with a sink. Instead, vessel rinsing device 600 enables self-draining through the same opening that a fluid connector (not explicitly depicted in FIG. 8) extends. Accordingly, vessel rinsing device 600 rests entirely on a sink deck rather than extending partially beyond as with vessel rinsing device 100, because no drain channel is needed with this example (this configuration is depicted particularly in FIGS. 4 and 5).

Moreover, in contrast with trigger plates 450, 550, trigger plate 650 extends over the entire top surface of drain bowl 622 which enables use of vessel rinsing device 600 with a variety of vessels having different diameters (e.g., vessels with diameters equal or less than a diameter of the trigger plate 650). Trigger plate 650 may also extend vertically inward into drain bowl 622 with respect to a top surface of upwardly extending wall 624, as illustrated by FIG. 8, rather than being flush with the top surface as in other vessel rinsing device examples.

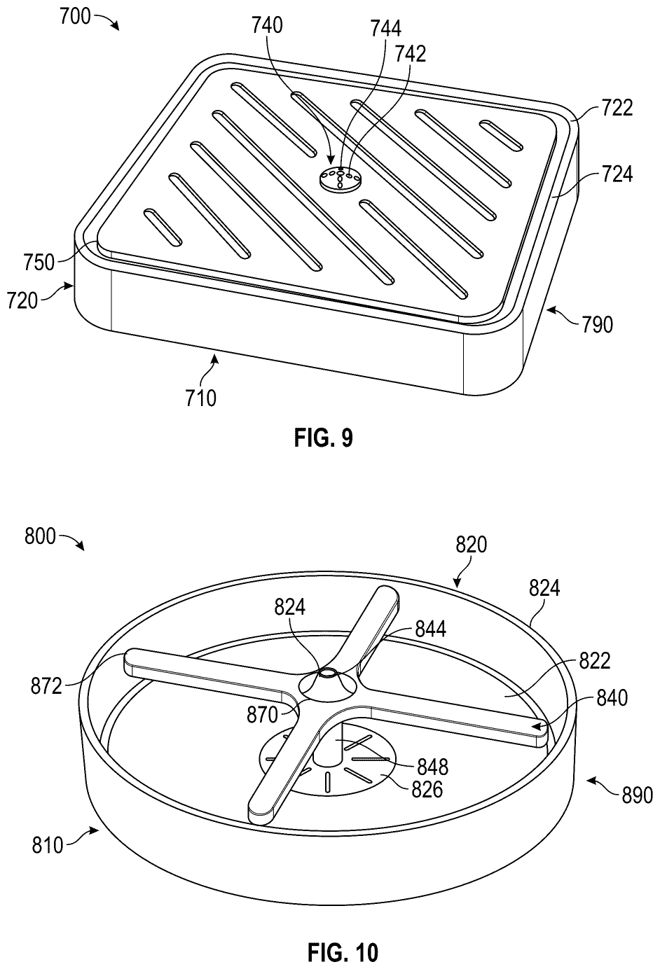

Referring now to FIG. 9, a vessel rinsing device 700 may include a mounting element 710 disposed below an escutcheon 720, a fluid dispersion assembly 740 disposed within the escutcheon 720, and a soap dispenser 790. Vessel rinsing device 700 has many similarities to vessel rinsing device 600 and for simplicity the description of common components is not repeated in the following. Like reference numerals and features names may designate like feature names throughout that are corresponding or analogous.

As illustrated, escutcheon 720 may have a square or rectangular geometry formed by the drain bowl 722 and the upwardly extending wall 724. As with escutcheon 620 of vessel rinsing device 600, escutcheon 720 includes a drain 726 (not explicitly depicted in FIG. 9) disposed directly inside the drain bowl 722 for removing contaminants which eliminates the need to define a drain channel in fluid communication with a sink. Moreover, trigger plate 750 may have a square or rectangular geometry to match the geometries of drain bowl 722 and upwardly extending wall 724. As illustrated in FIG. 9, trigger plate 750 can define a plurality of spaced-apart slots primarily for weight reduction and aesthetic purposes, as well as defining a central opening through which a fluid connector (not explicitly depicted in FIG. 9) and a dome 742 of fluid dispersion assembly 740 can extend through.

Referring now to FIG. 10, a vessel rinsing device 800 may include a mounting element 810 disposed below an escutcheon 820, a fluid dispersion assembly 840 disposed within the escutcheon 820, and a soap dispenser 890. Vessel rinsing device 800 has many similarities to vessel rinsing devices 100, 500 and for simplicity the description of common components is not repeated in the following. Like reference numerals and features names may designate like feature names throughout that are corresponding or analogous.

As illustrated, escutcheon 820 may have a circular geometry formed by the drain bowl 822 and the upwardly extending wall 824. As with escutcheon 620 of vessel rinsing device 600, escutcheon 820 includes a drain 826 disposed directly inside the drain bowl 822 for removing contaminants which eliminates the need to define a drain channel in fluid communication with a sink. In contrast to vessel rinsing devices 600, 700, the fluid dispersion assembly 840 of vessel rinsing device 800 includes a central connector 870 and a plurality of spaced-apart arms 872 extending from the central connector 870.

Similar to like features of vessel rinsing device 100, central connector 870 and plurality of arms 872 are generally integral such that they embody a single component when added to vessel rinsing device 800. Central connector 870 generally has a circular geometry with an aperture defined in a center portion. During assembly, dome 842 and fluid connector 848 can be inserted into the aperture to securely couple both central connector 870 and the plurality of arms 872 to these components. Each arm 872 of the plurality of arms 872 (shown as including four arms 872 in FIG. 10) generally extends outward from central connector 870 in a horizontal direction.

Plurality of arms 872 may comprise any suitable, narrow geometry but generally has a rectangular geometry with a rounded edge at an outermost end. In combination, central connector 870 and plurality of arms 872 may be configured to translate upward and downward relative to drain bowl 822 to activate (when moved downward) and turn off (when moved upward) the flow of water through the plurality of nozzles 844 defined within dome 842. Accordingly, central connector 870 and plurality of arms 872 effectively function as a “trigger” for the activation of vessel rinsing device 800 when a vessel is forced against the central connector 870 or the plurality of arms 872.

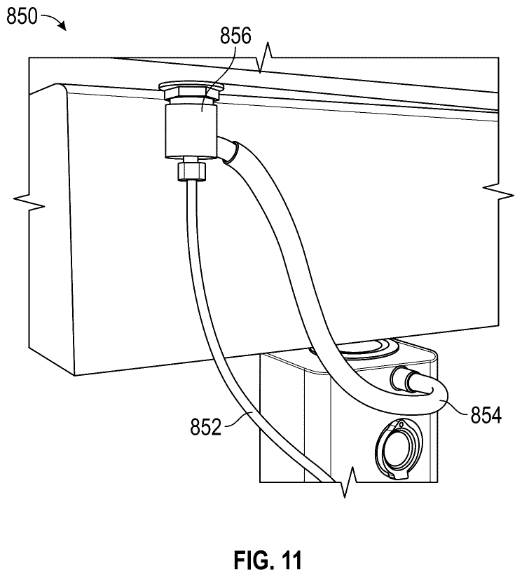

Referring now to FIG. 11, a drain assembly 850 for use with a vessel rinsing device 800 (and other vessel rinsing devices described herein) may include a fluid inlet hose 852, a drain outlet hose 854, and a connector 856 couplable to both the fluid inlet hose 852 and the drain outlet hose 854. Clean water may flow through fluid inlet hose 852 and into connector 856 which itself can be coupled to fluid connector 848 of vessel rinsing device 800. Conversely, wastewater and debris may flow into drain 826 and out through drain outlet hose 854 to an external wastewater and debris source. Accordingly, drain assembly 850 enables the transport of clean water to vessel rinsing device 800 for cleaning and rinsing operations, and the transport of wastewater and debris collected during and after cleaning and rinsing operations from drain bowl 822 to the external wastewater and debris source for final removal.

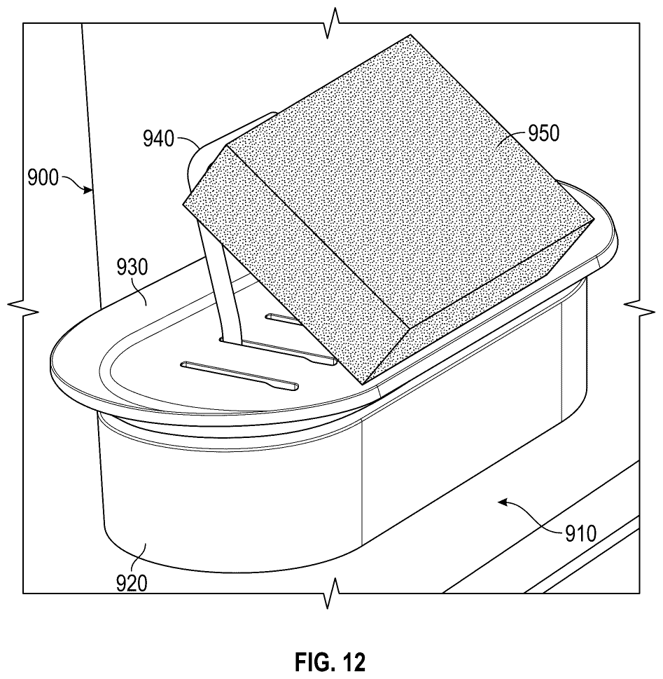

Referring now to FIG. 12, a drying apparatus 900 for use with a vessel rinsing device may include a mounting element 910 couplable to a sink deck, a base structure 920 generally positioned above the mounting element 910, a platform 930 generally positioned above the base structure 920, and a support bar 940 provided within the base structure 920 and being configured to extend partially through the platform 930. Drying apparatus 900 can be configured to receive a cleaning instrument 950 such as a sponge on the platform 930 and against the support bar 940 as illustrated by FIG. 12.

Mounting element 910, though not explicitly shown in FIG. 12, can be configured to couple drying apparatus 900 to a sink deck. Similar to mounting element 110, mounting element 910 may have an upper portion couplable to a bottom surface of the base structure 920 and a lower portion couplable to the sink deck. Mounting element 910 may have, for example, a cylindrically shaped geometry with threaded upper and lower portions to enable effective coupling to the sink deck. Mounting element 910 is generally made from a metallic material, though other suitable materials such as insoluble polymers, composite materials, and ceramics may be used. The length, width, diameter, and other measurements of mounting element 910 may vary depending on the type of sink deck or the preferences of the vessel rinsing device user.

Base structure 920 generally has a cylindrical shape with a bottom surface that rests on the sink deck when the drying apparatus 900 is coupled. Platform 930 is generally placed on a top surface of base structure 920 as shown in FIG. 12. Platform 930 can have a rounded edge surrounding an indented region having a plurality of slots or openings defined therein. Support bar 940 may extend through a pair of the plurality of slots or openings of platform 930 and can be oriented at an angle to enable a cleaning instrument 950 such as a sponge to be placed against the support bar 940 as shown in FIG. 12. Drying apparatus 900 may be manufactured from a variety of materials such as metals, insoluble polymers, composite materials, ceramics, or a combination thereof.

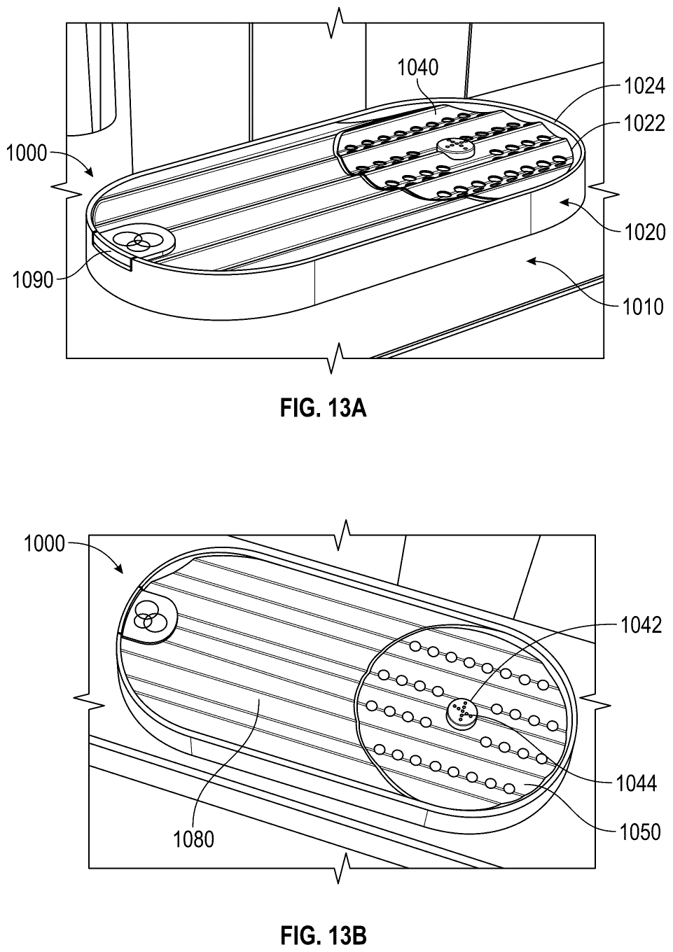

Referring generally to FIGS. 13A and 13B, a vessel rinsing device 1000 may include a mounting element 1010, an escutcheon 1020, a fluid dispersion assembly 1040, a drying platform 1080, and a soap dispenser 1090. Vessel rinsing device 1000 has many similarities to vessel rinsing devices 600, 700 and for simplicity the description of common components is not repeated in the following. Like reference numerals and features names may designate like feature names throughout that are corresponding or analogous.

Escutcheon 1020 generally has an oval slotted shape with fluid dispersion assembly 1040 provided on one end of the slot and drying platform 1080 provided on the other end. As shown in FIG. 13A, drain bowl 1022 of escutcheon 1020 can be covered such that drain (not depicted explicitly in FIGS. 13A and 13B) is defined within drain bowl 1022 but is generally not visible from the outside. Similar to previous vessel rinsing devices described herein, fluid dispersion assembly 1040 can be activated by applying a downward force to trigger plate 1050 which initiates water dispersal through a plurality of nozzles 1044 defined within a dome 1042. In examples, trigger plate 1050 may define a pattern of apertures along a top surface which can be used to drain wastewater and debris during and after vessel rinsing operations.

Drying platform 1080 may be used to store a cleaning instrument such as a sponge in a convenient location near where vessel cleaning and rinsing occurs (i.e., at the fluid dispersion assembly 1040). Drying platform 1080 is generally a flat surface sized to receive a cleaning instrument while leaving enough room for soap dispenser 1090 to be activated when desired by a user. As with vessel cleaning devices 600, 700, 800, vessel cleaning device 1000 can rest entirely on a sink deck rather than extending partially beyond the sink deck as with vessel rinsing device 100 (i.e., drain channel 146 creates fluid communication between a sink and drain bowl 142).

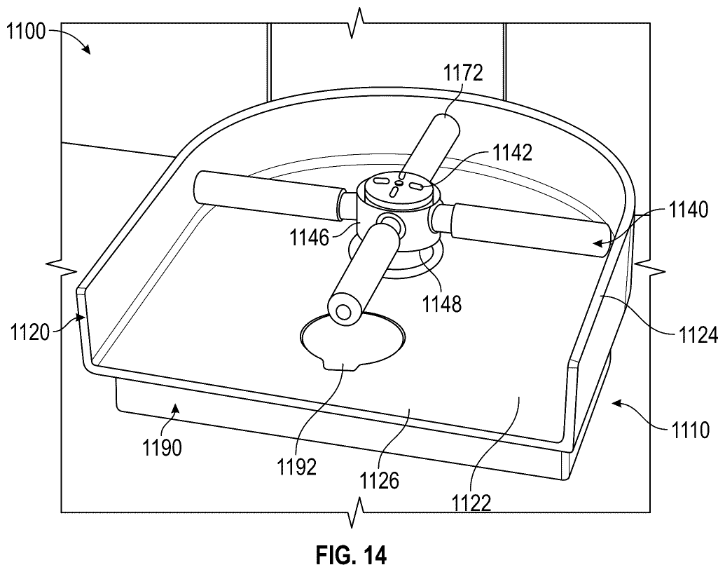

Referring now to FIG. 14, a vessel rinsing device 1100 may include a mounting element 1110, an escutcheon 1120, a fluid dispersion assembly 1140, and a soap dispenser 1190 with a plug 1192 defined into a drain bowl 1122 of escutcheon 1120. Soap dispenser 1190 is generally provided below escutcheon 1120 and can be coupled to a bottom surface thereof. Vessel rinsing device 1100 has many similarities to vessel rinsing device 800 and for simplicity the description of common components is not repeated in the following. Like reference numerals and features names may designate like feature names throughout that are corresponding or analogous.

Vessel rinsing device 1100 may include a plurality of arms 1172 configured to act as a “trigger” mechanism similar to those described previously. Additionally, alignment between any one of the plurality of arms 1172 and the plug 1192 defined within the drain bowl 1122 can enable the delivery of soap from the soap dispenser 1190 into the fluid connector 1148. At this point, fluid connector 1148 may already have water flowing from an external water source to the dome 1142 of the fluid dispersion assembly 1140. Accordingly, “soapy water” can be dispersed through the plurality of nozzles 1144 and into a vessel whenever an arm 1172 is aligned with the plug 1192. This advantageously provides a quick and easy approach to adding or removing soap to the vessel cleaning operations as desired by the user.

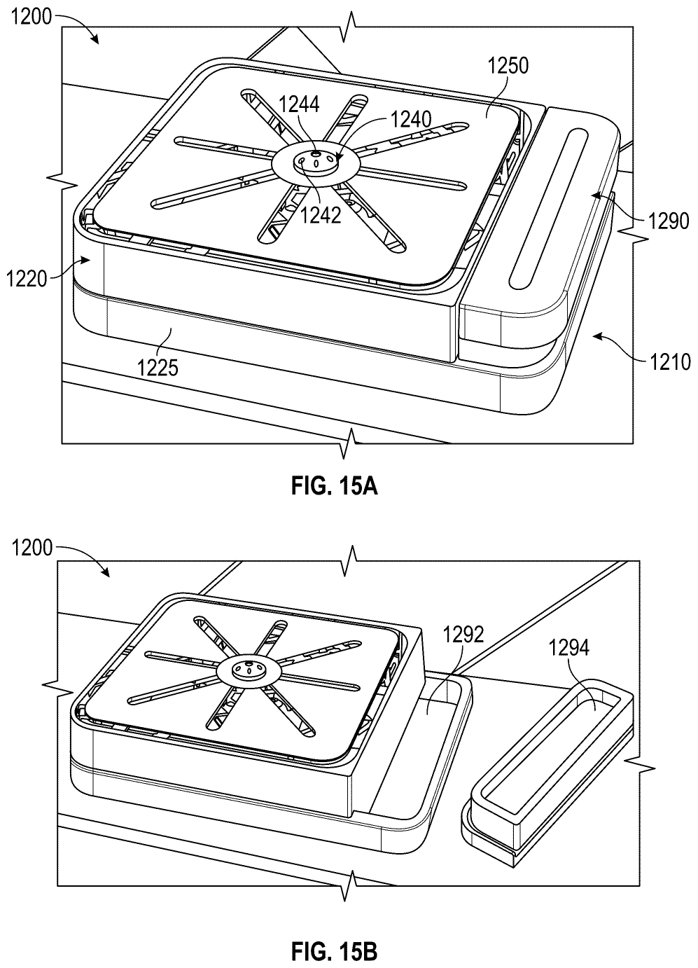

Referring generally to FIGS. 15A and 15B, a vessel rinsing device 1200 may include a mounting element 1210, an escutcheon 1220, a fluid dispersion assembly 1240, and a soap dispenser 1290 defining a chamber 1292 and having a cover 1294 over the chamber 1292. Vessel rinsing device 1200 has many similarities to vessel rinsing devices 600, 700 and for simplicity the description of common components is not repeated in the following. Like reference numerals and features names may designate like feature names throughout that are corresponding or analogous.

As with certain previous examples, escutcheon 1220 can define a square or rectangular-shaped drain bowl 1222 with an upwardly extending wall 1224 provided along a periphery of the drain bowl 1222. Internally, escutcheon 1220 may further define a drain (not depicted explicitly in FIGS. 15A and 15B) configured to receive wastewater and debris during and after completion of vessel rinsing operations. Additionally, escutcheon 1220 may define a lower portion 1225 that has a bottom surface flush with a sink deck and a top surface flush with a bottom surface of drain bowl 1222. Fluid dispersion assembly 1240 may include a dome 1242 defining a plurality of nozzles 1244 through which water or soap are dispersed from, a fluid connector (not depicted explicitly in FIGS. 15A and 15B) defined within drain bowl 1222, and a trigger plate 1250 which activates or stops water dispersal through the plurality of nozzles 1244.

Notably, soap dispenser 1290 can be integrated into lower portion 1225 of escutcheon 1220 as illustrated particularly in FIG. 15B. Soap dispenser 1290 can define a chamber 1292 for receiving soap or another cleaning product, and can define a cover 1294 to be placed over the chamber 1292 after the cleaning product has been inserted. Applying a sustained downward force (e.g., for approximately two seconds) against cover 1294 can enable dispersal of soap from chamber 1292 into the water flow through the fluid connector and out through the plurality of nozzles 1244. Accordingly, a mixture of water and soap (i.e., “soapy water”) may be generated using soap dispenser 1290. Advantageously, cover 1294 occupies a relatively large surface area of vessel rinsing device 1200 which can benefit users who prefer a larger soap dispensing “button” over one that has a smaller surface area.

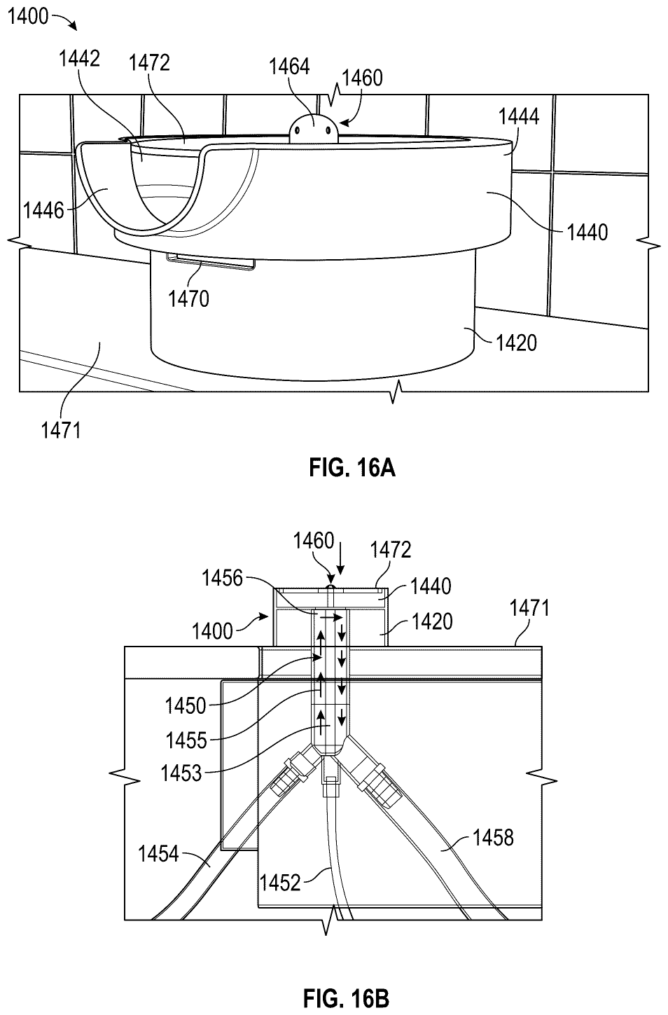

Referring now to FIGS. 16A and 16B, a vessel rinsing device 1400 may include an airgap device 1450 disposed at least partially within an interior of a lower escutcheon 1420 of the vessel rinsing device 1400. The lower escutcheon 1420 may be coupled to the sink deck 1471 with a mounting element (not pictured) or without a mounting element in various implementations.

The vessel rinsing device 1400 further comprises an upper escutcheon 1440. The upper escutcheon 1440 rests on, or is coupled to, the lower escutcheon 1420. The upper escutcheon 1440 is configured to couple to the lower escutcheon 1420 such that an opening 1470 is defined between the upper escutcheon 1440 and the lower escutcheon 1420. In an exemplary implementation, the opening 1470 is defined by removal of material from the lower escutcheon.

Like in various implementations previously described the upper escutcheon 1440 may include a drain bowl 1442, an upwardly extending wall 1444 defined on the periphery of drain bowl 1442, and a drain channel 1446 configured to channel water from the drain bowl 1442 and into a sink. Also like in other implementations, the upper escutcheon 1440 can comprise a trigger mechanism 1472 configured to dispense fluid through a plurality of nozzles 1464 of a fluid dispersion assembly 1460.

The airgap device 1450 can be disposed at least partially within the interior of the lower escutcheon 1420. The airgap device 1450 is configured to receive a fluid inlet hose 1452. The airgap device 1450 defines an internal fluid conduit 1453 configured to provide sealed fluid connection from the fluid inlet hose 1452 to the fluid dispersion assembly 1460. The sealed connection prevents mixing of fluid in the internal fluid conduit 1453 with wastewater in the airgap device (discussed in more detail below). Upon activation of the trigger mechanism 1472, fluid flows from the fluid inlet hose 1452, into the internal fluid conduit 1453, out the plurality of nozzles 1464, into the drain bowl 1442, out the drain channel 1446, and then into the sink.

The airgap device 1450 is further configured to receive a wastewater inlet hose 1454. In an exemplary implementation, the wastewater inlet hose 1454 is configured to receive wastewater from a dishwasher. The airgap device 1450 comprises an internal wastewater intake conduit 1455 in fluid communication with the wastewater inlet hose 1454. The internal wastewater intake conduit 1455 defines a sealed passageway for the wastewater to travel from a lower elevation to a higher elevation. At the higher elevation, the internal wastewater intake conduit 1455 dispenses the wastewater from a dispense point 1456 into an interior of the airgap device 1450. In an example, the internal wastewater intake conduit 1455 dispenses the wastewater horizontally, or substantially parallel to the sink deck. Once the wastewater is dispensed from the internal wastewater intake conduit 1455, it is exposed to ambient pressure due to the opening 1470, and the wastewater falls to a lower elevation within the airgap device 1450 due to gravitational forces.

The airgap device 1450 is further configured to receive a wastewater outlet hose 1458. The wastewater outlet hose 1458 is fluidly coupled to the airgap device 1450 at a lower elevation than the dispense point 1456, thereby allowing a gap of air between the dispense point 1456 and the wastewater outlet hose 1458. In an exemplary implementation, the airgap device 1450 is configured to receive the wastewater outlet hose 1458 at a bottom portion of the airgap device 1450. Wastewater is dispensed from the dispense point 1456 and gravitational forces cause the wastewater to drain out the wastewater outlet hose 1458 because it is at a lower elevation. In an exemplary implementation, the wastewater outlet hose 1458 is configured to dispose the wastewater into a garbage disposal or main drain line.

The fluid inlet hose 1452, wastewater inlet hose 1454, and wastewater outlet hose 1458, can be received by the airgap device 1450 by a threaded connection, for example. In other implementations, the hoses may be received by a push-fit, or any other method that can create a sealed connection between the hose and the airgap device 1450.

In some operating conditions, the wastewater outlet hose 1458, garbage disposal, or main drain line may be blocked. In a blocked condition, the wastewater will travel through the internal wastewater intake conduit 1455, out the dispense point 1456, but then be unable to exit the airgap device 1450 through the wastewater outlet hose 1458. Instead, the wastewater will begin to fill the airgap device 1450. Once the wastewater reaches the opening 1470, the wastewater will exit the opening 1470 and into the sink below. This feature may be desired, for example, to provide a relief point for wastewater to prevent a dishwasher from backing up and potentially overflowing with wastewater. Additionally, some health and safety codes require an airgap device for compliance. Combining an airgap device 1450 with a vessel rinsing device 1400 can efficiently utilize space around the sink, while potentially offering more desirable aesthetics.

It is to be appreciated that an airgap device 1450 can be similarly incorporated with any of the vessel rinsing devices previously disclosed. For example, the airgap device 1450 can be configured to operate with different shapes of lower and upper escutcheons 1420/1440, different triggering mechanisms 1472, or with Venturi systems to dispense a cleaning substance.

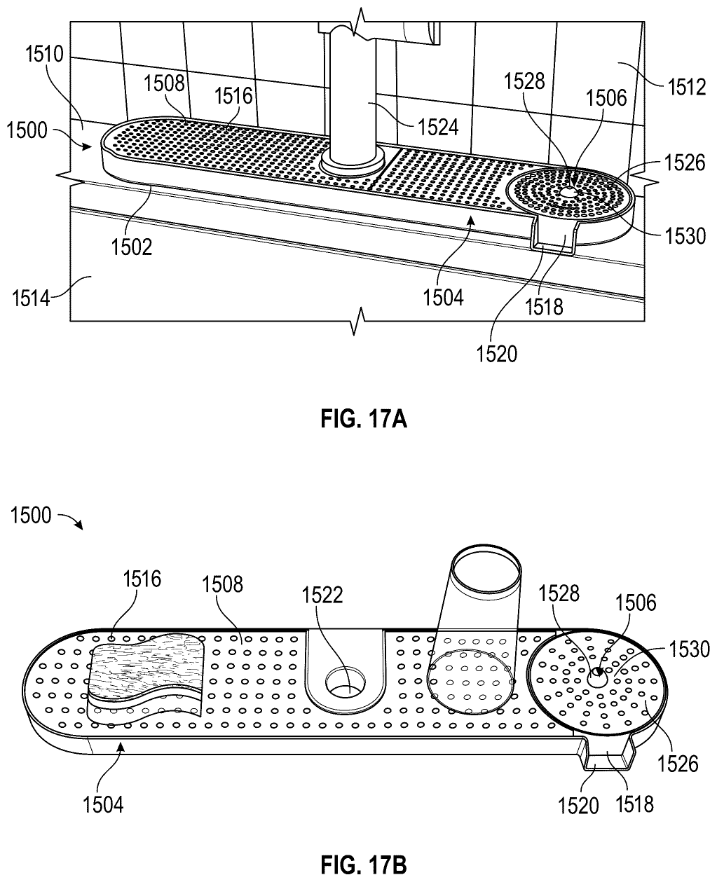

Referring generally to FIGS. 17A and 17B, an escutcheon with vessel rinsing device 1500 may include a mounting element 1502, an escutcheon 1504, a fluid dispersion assembly 1506, and a drying platform 1508.

Mounting element 1502, though not explicitly shown in the figures, can be configured to couple the escutcheon 1504 to a sink deck 1510 so device 1500 can be operated in the manner contemplated by this disclosure. Mounting element 1502 may have an upper portion couplable to a bottom surface of the escutcheon 1504 and a lower portion couplable to the sink deck 1510.

Mounting element 1502 may have, for example, a cylindrically shaped geometry with threaded upper and lower portions to enable effective coupling to the sink deck 1510. The sink deck 1510 generally defines an aperture through which the mounting element 1502 extends through, thereby enabling the bottom surface of the escutcheon 1504 to rest directly on a top surface of the sink deck 1510 when the mounting element 1502 is coupled to the sink deck 1510. Mounting element 1502 is generally made from a metallic material, though other suitable materials such as insoluble polymers, composite materials, and ceramics may be used. The length, width, diameter, and other measurements of mounting element 1502 may vary depending on the type of sink deck being used, the proximity of the sink deck to external plumbing features, or the preferences of the user of the escutcheon with vessel rinsing device 1500.

To enable water transport to the vessel rinsing device 1500, mounting element 1502 generally defines an internal chamber extending from one open end to another open end. For example, using the example of mounting element 1502 with upper and lower portions, the lower portion can define a first opening configured to receive a water transport element such as a hose or another suitable water passageway. The water transport element may extend through the internal chamber defined by the upper and lower portions and extend further beyond a second opening defined by the upper portion and into the escutcheon 1504 of the vessel rinsing device 1500. Accordingly, mounting element 1502 additionally enables the transport of water or other fluids from an external source to other components of vessel rinsing device 1500, to be used for vessel rinsing operations. In other implementations the escutcheon 1504 is coupled directly to the sink deck without the mounting element 1502.

Escutcheon 1504 can define a substantially oval area. The escutcheon 1504 can be generally shaped to fit on the sink deck 1510, between a back wall 1512 and back sink basin 1514. The escutcheon 1504 further provides a drying platform 1508 disposed across the area defined by the escutcheon 1504. In an exemplary implementation, the drying platform 1508 defines a plurality of draining apertures 1516. The escutcheon 1504 and drying platform can be made from a metal, such as stainless steel, or other suitable materials such as insoluble polymers, composite materials, and ceramics, or a combination thereof.

Further, the escutcheon 1504 comprises a drain bowl 1518 positioned below the drying platform 1508. The drain bowl 1518 can be sloped such that fluid flows towards a drain channel 1520. The drain channel 1520 is also sloped to dispense the fluid and debris into the sink basin below. In some implementations, a drain could be built into the drain bowl 1518, such that a drain channel 1520 is not needed. Such an arrangement may be desired to eliminate the drain channel 1520 from protruding over the sink basin. In some implementations the escutcheon 1504 can further incorporate an airgap device.

In use of the drying platform 1508, cleaning apparatuses like a sponge, or vessels such as cups, can be placed on the drying platform 1508, which is near where vessel cleaning and rinsing occurs. As fluid or debris drips down, the fluid or debris passes through the draining apertures 1516 and into the drain bowl 1518 below the drying platform 1508. The drain bowl 1518 is configured to then drain the fluid or debris out the drain channel 1520 and into the sink basin (or just down the drain in the escutcheon in some implementations).

A faucet neck opening 1522 is defined by the drying platform 1508 and drain bowl 1518 and is configured to receive a faucet neck 1524. In some implementations, the faucet neck opening 1522 fits around the faucet neck 1524 and in other implementations, the faucet neck 1524 is configured to fluidly couple to the faucet neck opening 1522. In an exemplary implementation, the faucet neck opening 1522 is substantially circular, but other shapes could be utilized to match with variously shaped faucet necks 1524. In an exemplary implementation, the faucet neck opening 1522 is disposed substantially central within the escutcheon 1504 and drying platform 1508.

In an exemplary implementation, the fluid dispersion assembly 1506 is disposed within the escutcheon 1504 and comprises a dome 1530, nozzles 1528 defined within the dome 1530, and a trigger plate 1526. The fluid dispersion assembly 1506 is in fluid connection with a fluid source, like a water line. The trigger plate 1526 is configured to open a valve to release the flow of fluid from the fluid source when the trigger plate 1526 receives a downward force (such as from a user pressing downwards on a vessel). When the trigger plate 1526 is activated by the downward force, fluid moves to the dome 1530 and out the nozzles 1528, which can be positioned on the dome 1530 to dispense the fluid in many directions. In use, this causes the fluid to be dispensed within a vessel that is pressed down over the fluid dispersion assembly 1506. Additionally, the drain bowl 1518 is configured to extend below the trigger plate 1526 as well as the drying platform 1508.

In some implementations, the fluid dispersion assembly 1506 can be configured to dispense soap or other cleaning solutions into the fluid stream, such that soap is applied to the interior of the vessel being rinsed. This could be done, for example, through various valves or Venturi systems. Further, the dome 1530 can be configured to rotate around an axis to spray fluid out of the plurality of nozzles 1528 and into the vessel all along a 360-degree path of rotation. Accordingly, each area of the dirtied vessel can be adequately reached to ensure complete cleaning and rinsing of the vessel. Additionally, the fluid dispersion assembly 1506 can be configured to allow a user to control the temperature of the fluid.

The trigger plate 1526 can be positioned substantially flush with the drying platform 1508 and the fluid dispersion assembly 1506 can be disposed at one of the ends of the drying platform 1508. In an exemplary implementation, trigger plate 1526 may define draining apertures 1516 along a top surface which can be used to drain wastewater and debris during and after vessel rinsing operations. The wastewater or debris can flow through the apertures 1516, into the drain bowl 1518, and out the drain channel 1520 into the sink basin. In other implementations, trigger plate 1526 can comprise a plurality of arms extending outward from the dome 1530. Further, in an exemplary implementation, the trigger plate 1526 requires more weight than a typical vessel or glass to trigger, thus allowing the trigger plate 1526 to be used as part of the drying platform 1508 without unintentionally activating the fluid dispersion assembly 1506.

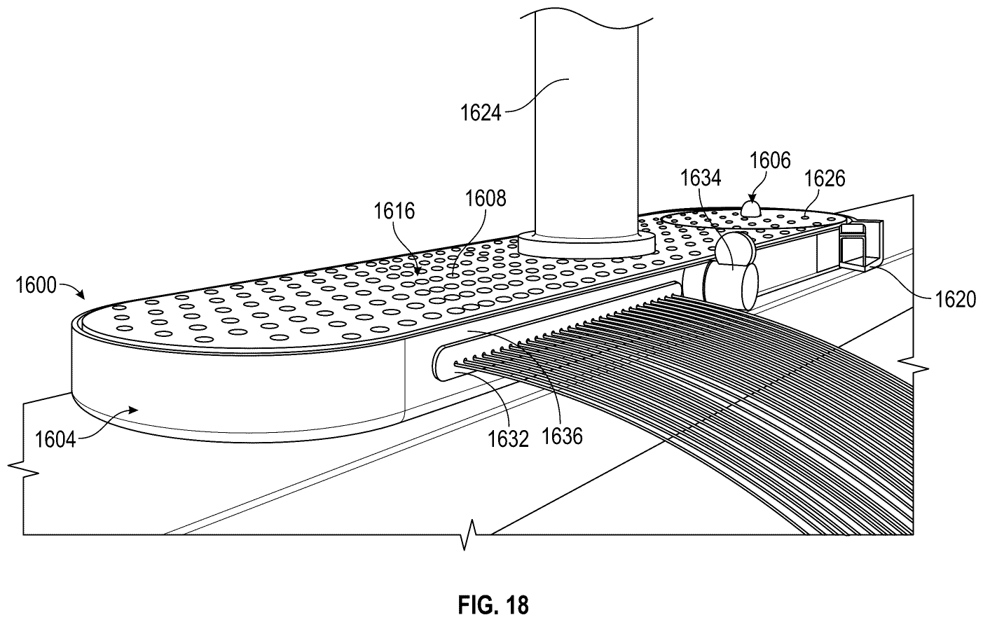

Referring now to FIG. 18, an escutcheon with vessel rinsing device 1600 and waterfall feature is shown. The escutcheon with vessel rinsing device 1600 of FIG. 18 is similar in many aspects to the escutcheon with vessel rinsing device 1500 of FIGS. 17A and 17B and corresponding elements are numbered similarly (that is, escutcheon 1504 corresponds to escutcheon 1604, for example).

In addition to features, various implementations, and methods of operation disclosed regarding FIGS. 17A and 17B, a plurality of escutcheon perforations 1632 can be defined by the escutcheon 1604. In such an application, the escutcheon 1604 can comprise an internal channel in fluid communication with the escutcheon perforations 1632 and a fluid source. The escutcheon perforations 1632 can be positioned on half of the escutcheon front face 1636 in one or more rows. In other implementations, the escutcheon perforations 1632 can be spread across nearly the whole width of the front face 1636 in one or more rows. Additionally, in various implementations the escutcheon perforations 1632 can be positioned more closely or further apart from each other. In some implementations the escutcheon perforations 1632 can be unevenly spaced from each other, allowing a user to utilize a greater volumetric flow rate on one end of the front face 1636 and a lesser volumetric flow rate on another. Similarly, the thickness of the escutcheon perforations 1632 may vary depending on the flow rate and pressure a user desires. In some implementations, the escutcheon perforations 1632 can comprise a single slot extending across at least a portion of the front face 1636.

In an exemplary implementation, an actuator shown here as a knob 1634 controls a valve to restrict or allow fluid to flow out of the escutcheon perforations 1632. In some implementations, partial manipulation of the knob 1634 can be configured to gradually increase or decrease the fluid flow rate through the escutcheon perforations 1632. In some implementations, the knob 1634 can also be used to control the temperature of the fluid. In use, a user can manipulate (by turning, pushing, twisting, or rotating, for example) the knob 1634 to allow fluid to flow through the escutcheon perforations 1632 and into the sink. Such a waterfall feature may be advantageous for washing certain items in the sink, such as produce, for example.

The disclosure may be embodied in other specific forms without departing from the essential attributes. Therefore, the illustrated examples should be considered illustrative and not restrictive in all respects. Any claims provided herein are to ensure adequacy of the present application for establishing foreign priority and for no other purpose.

Various examples of systems, devices, and methods have been described herein. These examples are given only by way of example and are not intended to limit the scope of the claimed disclosures. It should be appreciated, moreover, that the various features of the examples that have been described may be combined in various ways to produce numerous additional examples. Moreover, while various material, dimensions, shapes, configurations, locations, etc. have been described for use with disclosed examples, others besides those disclosed may be utilized without exceeding the scope of the claimed disclosures.

Persons of ordinary skill in the relevant arts will recognize that the subject matter hereof may comprise fewer features than illustrated in any individual example described above. The examples described herein are not meant to be an exhaustive presentation of the ways in which the various features of the subject matter hereof may be combined. Accordingly, the examples are not mutually exclusive combinations of features; rather, the various examples can comprise a combination of different individual features selected from different individual examples, as understood be persons of ordinary skill in the art. Moreover, elements described with respect to one example can be implemented in other examples even when not described in such examples unless otherwise noted.

Any incorporation of reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

What is claimed:

1. A vessel rinsing device, comprising:
an escutcheon;
a fluid dispersion assembly coupled to the escutcheon, the fluid dispersion assembly comprising:
a dome defining a plurality of nozzles, and
a trigger mechanism configured to control fluid spray through the plurality of nozzles; and
a soap dispenser configured to introduce soap into the fluid dispersion assembly to create a fluid and soap mixture sprayed through the plurality of nozzles.

2. The vessel rinsing device of claim 1, further comprising a mounting element configured to couple the escutcheon to a sink deck.

3. The vessel rinsing device of claim 1, wherein translational movement of the trigger mechanism toward the escutcheon activates fluid spray through the plurality of nozzles, and wherein translational movement of the trigger mechanism away from the escutcheon deactivates fluid spray through the plurality of nozzles.

4. The vessel rinsing device of claim 1, wherein the trigger mechanism comprises a plurality of arms extending outward from a central connector.

5. The vessel rinsing device of claim 1, wherein the trigger mechanism comprises a plate.

6. The vessel rinsing device of claim 1, wherein the escutcheon comprises a drain bowl coupled to a drain channel, and wherein the drain channel is configured to provide fluid communication between the drain bowl and a sink.

7. The vessel rinsing device of claim 1, wherein the dome is configured to rotate around the escutcheon.

8. The vessel rinsing device of claim 1, further comprising a light-emitting diode configured to provide illumination concurrently with activation of the trigger mechanism.

9. An escutcheon, comprising:
a platform defining a plurality of perforations in a sink-facing surface, wherein the plurality of perforations are in fluid communication with a fluid source;
a drain bowl coupled to the platform; and
a fluid dispersion assembly coupled to the drain bowl, the fluid dispersion assembly comprising a plurality of nozzles and a trigger mechanism configured to control fluid spray through the plurality of nozzles.

10. The escutcheon of claim 9, wherein the platform defines a first plurality of apertures in fluid communication with the drain bowl.

11. The escutcheon of claim 9, wherein the trigger mechanism comprises a trigger plate having a second plurality of apertures in fluid communication with the drain bowl.

12. The escutcheon of claim 9, further comprising a drain channel coupled to the drain bowl, the drain channel defining an opening along the sink-facing surface of the platform.

13. The escutcheon of claim 9, wherein the plurality of perforations are in fluid communication with the fluid source via an internal channel defined by the platform.

14. The escutcheon of claim 9, further comprising an actuator configured to control fluid spray through the plurality of perforations.

15. A vessel rinsing system, comprising:
an escutcheon defining a plurality of perforations in a sink-facing surface, wherein the plurality of perforations are in fluid communication with a fluid source;
a fluid dispersion assembly coupled to the escutcheon, the fluid dispersion assembly comprising:
a dome defining a plurality of nozzles, and
a trigger mechanism configured to control fluid spray through the plurality of nozzles; and
a soap dispenser configured to introduce soap into the fluid dispersion assembly to create a fluid and soap mixture sprayed through the plurality of nozzles.

16. The vessel rinsing system of claim 15, further comprising an airgap device disposed at least partially within the escutcheon.

17. The vessel rinsing system of claim 15, wherein the soap dispenser is disposed at least partially within a lower portion of the escutcheon, and wherein the fluid dispersion assembly is disposed at least partially within an upper portion of the escutcheon.

18. The vessel rinsing system of claim 15, wherein translational movement of the trigger mechanism toward the escutcheon activates fluid spray through the plurality of nozzles, and wherein translational movement of the trigger mechanism away from the escutcheon deactivates fluid spray through the plurality of nozzles.

19. The vessel rinsing system of claim 15, wherein the soap dispenser defines a cavity configured to hold soap and a cover removably coupled to the cavity, and wherein downward translation of the cover enables dispersal of soap from the cavity into the fluid dispersion assembly.

20. The vessel rinsing system of claim 15, further comprising an actuator configured to control fluid spray through the plurality of perforations.
